(19) United States
(12) Patent Application Publication
(10) Pub. No.: US 2008/0255003 A1
(43) Pub. Date: Oct. 16, 2008

(54) Fabrication Of Polymeric Structures

(75) Inventors: Sergey Anatoliyovich Piletsky, Cranfield Bedfordshire (GB); David Charles Cullen, Cambridge Cambridgeshire (GB); Olivier Yves Henry, Concarneau (FR)

Correspondence Address: STITES & HARBISON PLLC, 1199 NORTH FAIRFAX STREET, SUITE 900, ALEXANDRIA, VA, 22314, US

(73) Assignee: CRANFIELD UNIVERSITY, Bedfordshire (GB)

(21) Appl. No.: 11/569,403

(22) PCT Filed: May 23, 2005
(86) PCT No.: PCT/GB2005/002024

§ 371 Date: Mar. 3, 2008

(30) Foreign Application Priority Data
May 21, 2004 (GB) 0411348.6

(51) Int. Cl. C40B 50/18

(52) U.S. Cl. 506/32

(57) ABSTRACT

A substrate in contact with a solution of polymerisable monomer(s) is subjected to patterned localised heating by means of a scannable laser, causing local polymerisation with generation of a pattern of polymer. The resulting patterned polymer array can be used e.g. in assay devices.

### TECHNICAL FIELD

Broadly the present invention describes the fabrication of spatially controlled polymeric structures using a radiation or particle beam. The resulting structures find use in a variety of electrophoretic and sensor applications, including clinical assays, high throughput screening for genomics, proteomics and pharmaceutical applications, point-of-care in vitro diagnostics, molecular genetic analysis and nucleic acid diagnostics, cell separations, and bioresearch generally, high throughput screening of materials for separation and catalysis.

Background Art

| Patent | Country | Issued | Title |
|---|---|---|---|
| 6,656,668 | USA | Dec. 2, 2003 | Process method of using |
| | | | excimer laser for forming |
| | | | micro spherical and non- |
| | | | spherical polymeric |
| | | | structure array |
| 6,480,324 | USA | Nov. 12, 2002 | Methods involving direct |
| | | | write optical lithography |
| 0028804A1 | USA | Feb. 12, 2004 | Production of polymeric |
| | | | micro-arrays |
| 6,544,698 | USA | Apr. 8, 2003 | Maskless 2-D and 3-D |
| | | | pattern generation |
| | | | photolithography |
| US2003186140 | USA | Feb. 10, 2003 | Maskless photolithography |
| | | | for using photoreactive |
| | | | agents |
| EP1331516 | USA | Jul. 30, 2003 | Method and mask for |
| | | | fabricating features in |
| | | | a polymer layer |

Microarray fabrication technology has been developed recently, based on the deposition of a discrete amount of materials using a robotic handling device. In this approach an array of liquid pre-polymerisation mixture comprising of liquid monomer that may be combined with other monomer(s), solvent, initiator, chemical and biochemical compound(s), dissolved polymer is first deposited on a substrate and then polymerised in situ by presenting the array to initiating conditions. This approach suffers from the difficulty of maintaining integrity of the materials deposited before exposure to initiating conditions, which has large consequences on the quality of the resulting polymeric structures. Evaporation, effect of presence of oxygen, surface properties of the substrate, quantity that can be deposited and shapes of structures that can be fabricated all affect the quality and quantity of deposited material making it very difficult to control.

Polymer arrays can be formed using photomasks (EP1331516). This method is similar to manufacturing integrated circuits. Light is applied through a mask that has a predefined image pattern which leads to initiation at polymerisation in certain regions of a substrate but not in others. The substrate can include solids, such as silicon, glass, quartz, and polymers. The fabrication of a multicomponent array in general requires the use of multiple varieties of masks, which is not always convenient. In addition this approach suffers from the limitations highlighted above.

According to another approach, direct optical photolithography can be performed with an optical beam without the use of photomasks (U.S. Pat. No. 6,480,324). The light patterns are generated by a spatial light modulator controlled by a computer, rather than being defined by a pattern on a photomask. Here each pixel is illuminated with an optical beam of suitable intensity and the imaging (printing) of an individual feature on a substrate is determined dynamically by computer control. This invention employs a programmable micro-mirror array, which plays an essentially similar role to photomask. It is centered around the development of nucleic acid arrays and also involves photochemistry. Many of the compounds that are potentially useful for manufacturing polymer arrays are photosensitive and can decompose upon illumination.

### DISCLOSURE OF INVENTION

A preferred embodiment of the invention can provide a fabrication method that avoids or reduces the limitations mentioned above in order to produce patterned polymeric structures. Thus the invention provides a method of fabricating a structure or pattern comprising a polymeric material on a substrate, comprising (a) providing a substrate; (b) providing a liquid phase comprising a polymerisable material in contact with a surface of said substrate; (c) directing a radiation beam to impinge on said surface at the substrate/liquid phase interface so as to initiate polymerisation adjacent the irradiated site; and (d) causing the beam to scan in a predetermined pattern, thereby initiating polymerisation in a corresponding pattern. NB The reference to causing the beam to “scan” means that it is caused to move across the surface in a controlled way corresponding to a desired pattern which can be continuous or discontinuous (or both in different regions).

The beam is preferably a laser beam, especially an IR laser beam.

Spatially controlled polymeric structures are fabricated by using a laser beam, preferably an IR heat generating CO₂ laser, which initiates polymerisation on the pre-determined areas of surface. The polymer structures are created on a substrate surface by directing the laser beam according to a pre-determined pattern. Accordingly the invention provides a means to grow, rather than deposit, polymers of desired shapes from a pre-polymerisation mixture in the liquid phase on a substrate as predetermined by a user. The subject devices find use in a variety of electrophoretic and sensor applications, including clinical assays, high throughput screening for genomics, proteomics and pharmaceutical applications, point-of-care in vitro diagnostics, molecular genetic analysis and nucleic acid diagnostics, cell separations, and bioresearch generally, high throughput screening of materials for separation and catalysis.

A preferred embodiment of the invention will now be described with reference to the accompanying drawings.

### BRIEF DESCRIPTION OF DRAWINGS

FIG. 1 shows a schematic of the embodiment of the invention

FIG. 2 shows an alternative embodiment of the invention

FIG. 3 is a photograph of an array of 25 polymer dots produced according to an embodiment of the invention as shown in FIG. 1

FIG. 4 is a photograph of a single dot

### MODES FOR CARRYING OUT THE INVENTION

The first embodiment of the present invention describes performing of the polymer deposition using IR laser with electromechanical laser galvanometer scanning system. The set-up consists of a reservoir 2 containing a solution 3 comprising a mixture of monomer(s) with initiator dissolved in an appropriate solvent. The monomer mixture is in contact with a thin sheet 1 of a substrate. Typically the substrate covers the reservoir, and a laser beam 4 is applied from above (4).

The laser beam is generated by a CO₂ infrared laser 10 and passes to a movable mirror 12, moved by a motor 14 controlled by a computer 16. The diagram is highly schematic; in practice we used a commercial product, a FENIX laser marker (SYNRAD, Inc, Wisconsin, USA), with a 30 W CO₂ laser and an X-scanning mirror. Laser beam 4 is directed to pass through the substrate (1) following a user-designed pattern. It heats locally zones of the substrate. The initiator in close proximity to these zones at the lower surface of the substrate decomposes, initiating polymerisation. The growth of polymer structures 5 is dependent on factors such as beam intensity, time of exposure, and properties of the substrate and its surface.

In some embodiments of the present invention the properties of the substrate and/or the wavelength and/or intensity of the laser beam are adapted using methods well established in the art, to allow higher control over the polymer adhesion, morphology and polymerisation time. Thus the surface of the substrate can be optionally modified with polymerisable compound or with immobilised initiator molecules to promote polymer growth and adhesion.

In some embodiments, initiator is not present in the solution and is used only in immobilised form.

The pre-polymerisation mixture may contain one or several monomers and be combined with solvents, polymerisation initiators, dissolved polymers, natural or synthetic biochemical and chemical compounds.

A reservoir for holding the mixture can be made of silicon, glass, metal, plastic, ceramic or a combination of these. The cavity containing pre-polymerisation mixture may be emptied and re-filled with pre-polymerisation mixture of varying compositions to allow for the fabrication of an array of structures of varying nature, composition and properties. This also offers the possibility to fabricate layered polymeric structures by successively growing polymer layers of different nature on top of each other.

In other embodiments of the invention the energy will be applied to initiate polymerisation in different ways, including using light (e.g. an excimer laser), focused ionic, particle, X-ray and electron beams. The pattern can be changed by re-focusing and re-directing the applied energy.

In some embodiments of the invention, the monomer mixture contains template molecules which will be extracted from the formed polymer structures creating imprinted cavities capable of selective recognition, signalling or catalysis. Development of these materials (molecularly imprinted polymers) is a well established process. Depending on the application, functional monomer(s) and/or template can contain fluorescent tags (reporters) which will allow detection of target compounds. The application of fluorescent tags and environmental sensitive probes is well known in the art.

The invention is also concerned with the application of the fabricated spatially controlled polymeric structures. These devices may be used in a variety of applications, including, e.g., high throughput screening assays in drug discovery, immunoassays, diagnostics, genetic analysis, and the like. In another aspect the structures (arrays) will be used as sensor components, lab-on-a-chip for performing chemical and/or biological experiments and as research platform for studying and optimising separation, molecular recognition and catalytic processes.

While advantageous embodiments have been chosen to illustrate the invention, it will be understood by those skilled in the art that various changes and modifications can be made therein without departing from the scope of the invention as defined in the corresponding embodiments.

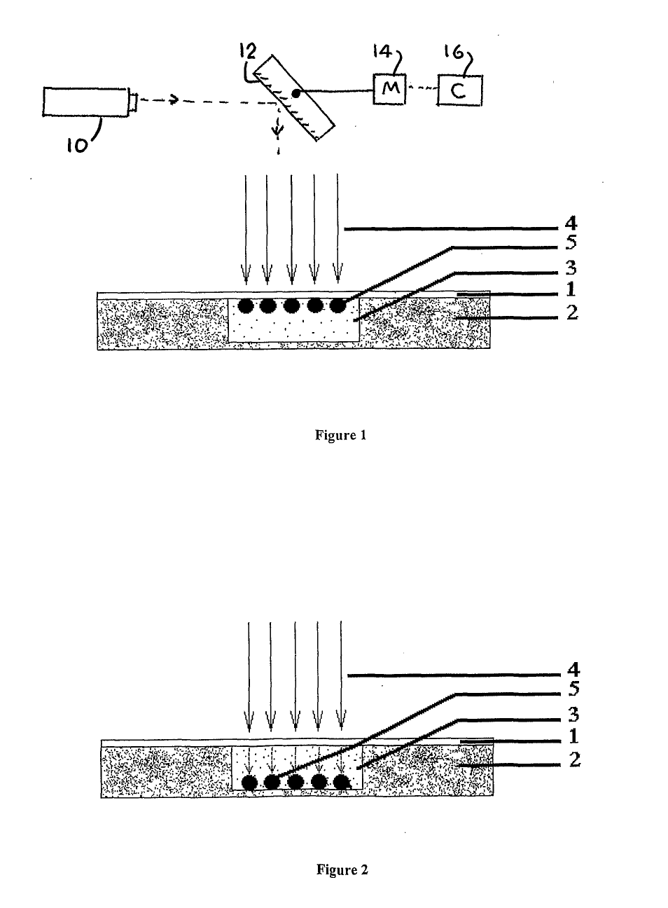

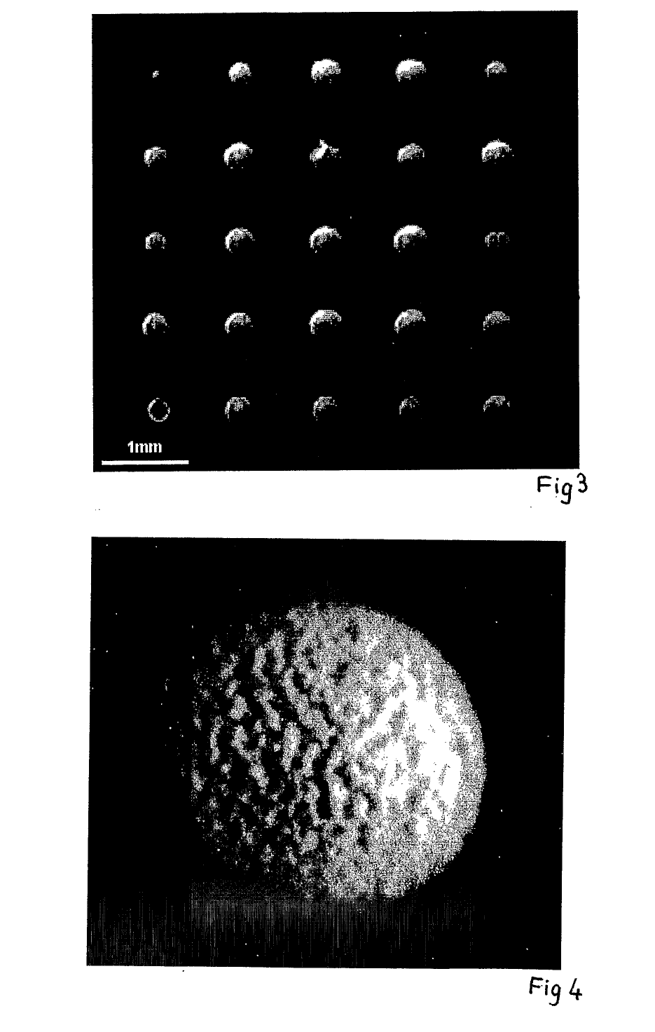

The present invention will now be further particularly described with reference to the following, non-limiting examples.
1. Development of “top” polymer array. This used apparatus as shown in FIG. 1. The pre-polymerisation mixture consisted of the monomers methacrylic acid (MAA) and 2-vinylpyridine (2-VyP), the cross-linker ethylene glycol dimethacrylate (EGDMA), the porogen poly(vinyl acetate) (PVA), and the initiator azobisisobutyronitrile (AIBN), all dissolved in acetonitrile. The substrate (1) was a microscope cover slip made of borosilicate glass. The laser employed was a CO₂ infrared LASER (λ=1066 nm) and was programmed to scan repeatedly 25 dots as laser pulses, organised in an array of 5 by 5 dots. In this particular example local heat was generated at the surface of substrate (1) as borosilicate is non-transparent to infrared light. Heat pulses generated locally during each laser pulse initiated the polymerisation process and produced dots such as the ones depicted in FIG. 3. The enlarged image of a single dot is presented in FIG. 4.
2. Development of “bottom” polymer array. This used apparatus as shown in FIG. 2. The pre-polymerisation mixture was the same as in Example 1. The apparatus was largely the same, except that the cover layer 21 was of a material substantially transparent to the laser radiation, in this case a 3 mm thick silver halide (AgClₓBr₁₋ₓ) glass. As before, the laser was programmed to scan repeatedly 25 dots as laser pulses, organised in an array of 5 by 5 dots. In this example, local heat was generated at the bottom of the reservoir, in a substrate layer 22. Thus the polymer pattern was generated there.
   Materials for use as cover layers and/or bottom substrates include glass, plastic, metal, ceramic, quartz, ceramic, silver halide (AgClₓBr₁₋ₓ) and combinations of these. If the invention is to produce an array on a bottom layer, then plainly the cover layer must be at least partly transparent to the radiation. It may still heat up significantly if use is made of initiator coated on the bottom layer instead of being in solution. Of course the “bottom substrate” does not need to be the bottom of the reservoir, but could be an element of sheet material placed in the reservoir.

1. A method of fabricating a structure or pattern comprising a polymeric material on a substrate, comprising (a) providing a substrate; (b) providing a liquid phase comprising a polymerisable material in contact with a surface of said substrate; (c) directing a radiation beam to impinge on said surface at the substrate/liquid phase interface so as to cause localized heating of the substrate and thereby initiate polymerization adjacent the irradiated site; and (d) causing the beam to scan in a predetermined pattern, thereby initiating polymerization in a corresponding pattern.

2. A method according to claim 1 wherein said beam is a beam of visible light, IR, UV, X-rays, ions, particles or electrons.

3. A method according to claim 2 wherein the beam is a laser beam.

4. A method according to claim 1 wherein the beam is IR.

5. A method according to claim 1 wherein the beam is directed through the substrate to the interface and generates heat by interaction with the substrate.

6. A method according to claim 1 wherein said beam is an infrared laser beam.

7. A method according to claim 1 wherein said polymerisable material is thermally polymerisable, and the beam generates heat to initiate polymerization.

8. A method according to claim 1 wherein said liquid phase is a solution comprising polymerisable monomers.

9. A method according to claim 8 wherein the solution contains a polymerization initiator.

10. A method according to claim 1 wherein said surface bears immobilized initiator molecules.

11. A method according to claim 1 wherein said surface bears immobilized polymerisable material.

12. A method according to claim 1 wherein the scanning step employs a computer controlled movable mirror.

13. A method according to claim 1 wherein after step (d), the liquid phase is replaced by a different liquid phase and steps (c) and (d) are repeated to deposit a second, different polymeric material.

14. A method according to claim 1 wherein said liquid phase contains template molecules and, after step (d) template molecules are removed from the polymer to form imprinted cavities.

15. A method according to claim 1 including a subsequent step of using the fabricated structure or pattern in a process selected from high throughput screening assays for drug discovery, immunoassays, diagnostics, genetic analysis, or as a sensor component, lab-on-a-chip for performing chemical and/or biological experiments or as a research platform for studying and optimizing separation, molecular recognition or catalytic processes.
